(19) United States
(12) Patent Application Publication
(10) Pub. No.: US 2007/0087691 A1
(43) Pub. Date: Apr. 19, 2007

(54) Apparatus and method for supporting multi-link in multi-hop relay cellular network

(75) Inventors: Mi-Hyun Lee, Seoul (KR); Pan-Yuh Joo, Seoul (KR); Jung-Je Son, Seongnam-si (KR); Jae-Weon Cho, Suwon-si (KR); Hyoung-Kyu Lim, Seoul (KR); Yeong-Moon Son, Anyang-si (KR); Sung-Jin Lee, Seoul (KR); Hyun-Jeon Kang, Seoul (KR); Song-Nam Hong, Seoul (KR); Young-Ho Kim, Suwon-si (KR)

Correspondence Address: DILWORTH & BARRESE, LLP, 333 EARLE OVINGTON BLVD., SUITE 702, UNIONDALE, NY, 11553, US

(73) Assignee: Samsung Electronics Co., Ltd.

(21) Appl. No.: 11/541,332

(22) Filed: Sep. 29, 2006

(30) Foreign Application Priority Data
Sep. 29, 2005 (KR) 2005-0091101

(51) Int. Cl. H04B 7/19

(52) U.S. Cl. 455/13.2

(57) ABSTRACT

A framing method of fixing a training signal and a control channel for multi-link (direct link and relay link) synchronization in a multi-hop relay cellular network, and a transmitting/receiving apparatus for supporting the framing method. A base station (BS) transmits BS downlink (DL) subframe sequentially including a preamble, control information, and a DL burst to a relay station (RS) or a first mobile station (MS) connected to the BS by direct link. The RS transmits an RS DL subframe sequentially including a DL burst, a postamble, and control information to a second MS connected to the BS by relay link. Therefore, difficulties of initial synchronization, handoff, and cell search can be removed from MSs. Furthermore, multi-link bursts can be located between the preamble and the postamble by Time Division Multiplexing (TDM) or Frequency Division Multiplexing (FDM).

### PRIORITY

This application claims priority under 35 U.S.C. § 119 to a Korean application filed in the Korean Intellectual Property Office on Sep. 29, 2005 and allocated Serial No. 2005-91101, the contents of which are incorporated herein by reference.

### BACKGROUND OF THE INVENTION

1. Field of the Invention

The present invention relates generally to a multi-hop relay cellular network, and more particularly, to a framing method of fixing a training signal and a frame control channel for multi-link (direct link and relay link) synchronization in a multi-hop relay cellular network, and a transmitting/receiving apparatus for supporting the framing method.

2. Description of the Related Art

Nowadays, many people carry a variety of digital electronic devices, such as notebook computers, portable phones, Personal Digital Assistants (PDAs), MPEG 1 Audio Layer 3 (MP3) players, etc. In most cases, portable digital electronic devices operate independently without interaction with one another. If portable digital electronic devices themselves can configure a wireless network without the aid of a central control system, they can easily share various data with one another, which makes it possible to provide a variety of novel data communication services. Such a wireless network capable of providing communications between devices whenever and wherever without the aid of a central control system is called an “ad-hoc network” or a “ubiquitous network”.

Researches are being actively conducted on a fourth-generation (4G) mobile communication system, and a self-configurable wireless network is one of the most important desires for the 4G mobile communication system.

A self-configurable wireless network makes it possible to provide a mobile communication service by configuring a wireless network independently or in a distributed fashion without the aid of a central control system. In a 4G mobile communication system, a plurality of cells with a very small radius are installed to provide high-rate data communication and accommodate a large amount of traffic. In a 4G mobile communications system, it is impossible to implement a centralized network using an existing wireless network design. A 4G wireless network should actively provide for an environment change, such as an addition of new base stations (BSs), while being constructed and controlled in a distributed fashion. For this reason, the 4G mobile communication system should be arranged as a self-configurable wireless network.

Technologies for an ad-hoc network are introduced in a mobile communication system to implement a self-configurable wireless network for a 4G mobile communication system. A typical example of this is a multi-hop relay cellular network in which a multi-hop relay scheme for the ad-hoc network is introduced in a cellular network configured with a stationary BS.

In a cellular network, it is possible to easily establish a high-reliability wireless communication link between a BS and a mobile station (MS) because communication between the BS and the MS is performed through one direct link.

However, because the BS is stationary, flexibility in construction of a wireless network is low in a cellular network, which makes it difficult to provide efficient service in an environment with a great change in traffic distributions or requirements.

In order to overcome this difficulty, a relay scheme is used that transmits data in a multi-hop fashion through neighboring MS or relay stations (RSs). The multi-hop relay scheme makes it possible to rapidly reconstruct a network suitable for peripheral environments and to efficiently operate the entire wireless network. Furthermore, since the RS is located between a BS and an MS for establishing a multi-hop relay path, an improved wireless channel can be provided to the MS. Moreover, the multi-hop relay path can be used to provide a high-rate data channel to MSs located in a shadow area where the MSs cannot communicate directly with a BS, thereby making it possible to expand a cell coverage area.

FIG. 1 shows a multi-hop relay cellular network according to the prior art. An MS 110, which is located inside a coverage area 101 of a BS 100, communicates directly with BS 100. On the contrary, MS 120, which is located outside the coverage area 101 and thus has poor channel conditions, communicates indirectly with BS 100 through RS 130.

There is a case where MSs 110 and 120 communicate directly with the BS 100 but has poor channel conditions because they are located at the edge of the BS coverage area 101. In this case, RS 130 can be used to provide a better radio channel. Therefore, using a multi-hop relay scheme, BS 100 can provide a high-rate data channel in a cell boundary region with a poor channel condition and thus can expand a cell service area (i.e., the coverage area 101).

Therefore, a need exists to provide a frame structure capable of supporting a direct link and a relay link in one frame so that MS 120 can communicate with RS 130 as well as BS 100.

### SUMMARY OF THE INVENTION

An object of the present invention is to substantially solve at least the above problems and/or disadvantages and to provide at least the advantages below. Accordingly, an object of the present invention is to provide a method for constructing a frame for supporting a multi-link in a multi-hop relay cellular network, and a transmitting/receiving apparatus for supporting the method.

Another object of the present invention is to provide a method of constructing a frame in which a training signal and a frame control channel are located at fixed positions for supporting multi-link (direct link and relay link) synchronization in a multi-hop relay cellular network, and a transmitting/receiving apparatus for supporting the framing method.

According to one aspect of the present invention, there is provided an RS transmitter in a multi-hop relay cellular network, the RS transmitter including a frame constructor for generating a DL subframe to be transmitted to an MS, the DL subframe including a DL burst, a training signal in a postamble, and a control channel; and a timing controller for generating a timing signal providing information about a time period for transmitting the DL subframe.

According to another aspect of the present invention, there is provided an MS receiver in a multi-hop relay cellular network, the MS receiver including a frame extractor for splitting a DL subframe of an i^{th} frame received from an RS into a DL burst, a training signal, and a control channel; and a synchronization detector for acquiring a synchronization signal from training signals of the i^{th} frame; and a timing controller for providing a timing signal used for receiving a DL subframe of an (i+1)^{th} frame according to the synchronization signal.

According to a further another aspect of the present invention, there is provided a method for operating an RS to transmit data in a multi-hop relay cellular network, the method including constructing a DL subframe sequentially including DL data, a training signal, and a control channel; transmitting the DL subframe to an MS; and switching the RS into a receiving (RX) mode.

According to a still further another aspect of the present invention, there is provided a method for operating an MS to receive data in a multi-hop relay cellular network, the method including when receiving a DL subframe of an i^{th} frame is received from an RS, acquiring a synchronization signal using a training signal. included in the DL subframe; determining a start point of a DL subframe of an (i+1)^{th} frame to be received from the RS by using a control channel included in the DL subframe of the i^{th} frame; and when the (i+1)^{th} frame is received from the RS, receiving the DL subframe of the (i+1)^{th} frame based on the start point determined using the control channel or control information.

According to a yet further another aspect of the present invention, there is provided a method for constructing a subframe in a multi-hop relay cellular network, the method including constructing a first subframe in a first section of the subframe for transmitting the first subframe from a BS to an RS or a first MS connected to the BS by a direct link, the first subframe sequentially including a synchronization channel, control information, and a DL burst; and constructing a second subframe in a second section of the subframe for transmitting the second subframe from the RS to a second MS connected to the RS by a relay link, the second subframe sequentially including a DL burst, a synchronization channel, and control channel.

### BRIEF DESCRIPTION OF THE DRAWINGS

The above and other objects, features and advantages of the present invention will become more apparent from the following detailed description when taken in conjunction with the accompanying drawings in which:

FIG. 1 illustrates a multi-hop relay cellular network according to the prior art;

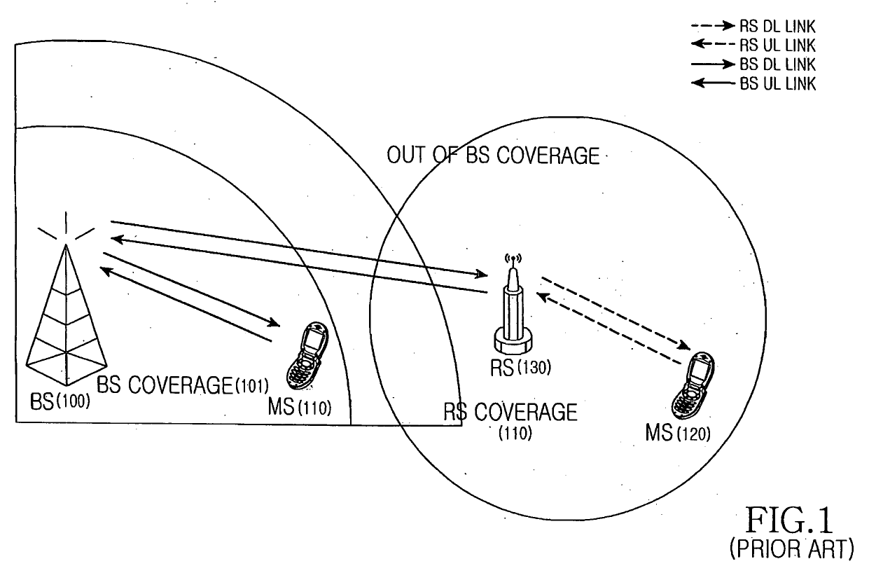

FIG. 2 illustrates a frame format for a TDM multi-hop relay cellular network according to the present invention;

FIG. 3 illustrates dynamic changes of subframe lengths in a multi-hop relay cellular network depending on the load of a cell according to the present invention;

FIG. 4 illustrates a frame format for a TDM multi-hop relay cellular network according to the present invention;

FIG. 5 illustrates a frame format for an FDM multi-hop relay cellular network according to the present invention;

FIG. 6 illustrates an operation scenario of a frame format for a. TDM multi-hop relay cellular network according to the present invention;

FIG. 7 is a block diagram of a base station transmitter according to the present invention;

FIG. 8 is a flowchart for illustrating transmission procedures of a base station according to the present invention;

FIG. 9 is a block diagram of a relay station transmitter according to. the present invention;

FIG. 10 is a flowchart for illustrating transmission procedures of a relay station according to the present invention;

FIG. 11 is a block diagram of a mobile station receiver receiving a signal from a relay station according to the present invention; and

FIG. 12 is a flowchart for illustrating operational procedures,of a mobile station receiving a signal from a relay station according to the present invention.

### DETAILED DESCRIPTION OF THE PREFERRED EMBODIMENTS

Preferred embodiments of the present invention will be described herein below with reference to the accompanying drawings. In the following description, well-known functions or constructions are not described in detail since they would obscure the invention in unnecessary detail.

Hereinafter, a framing method of fixing a training signal and a control channel for multi-link (direct link and relay link) synchronization in a multi-hop relay cellular network, and a transmitting/receiving apparatus for supporting the framing method will now be described in detail. In the following description, Time Division Duplex (TDD) and Orthogonal Frequency Division Multiplexing Access (OFDM) wireless communication systems are used to explain the present invention. However, the present invention can be applied to other wireless communication systems. Further, a mobile station that connects to a base station by establishing a direct link is referred herein to as MS_{BS}, and a mobile station that connects to the base station through a relay station by establishing a multi-hop relay link is referred herein to as MS_{RS}, That is, a mobile station can be an MS_{BS} or an MS_{RS} depending on its location and capability.

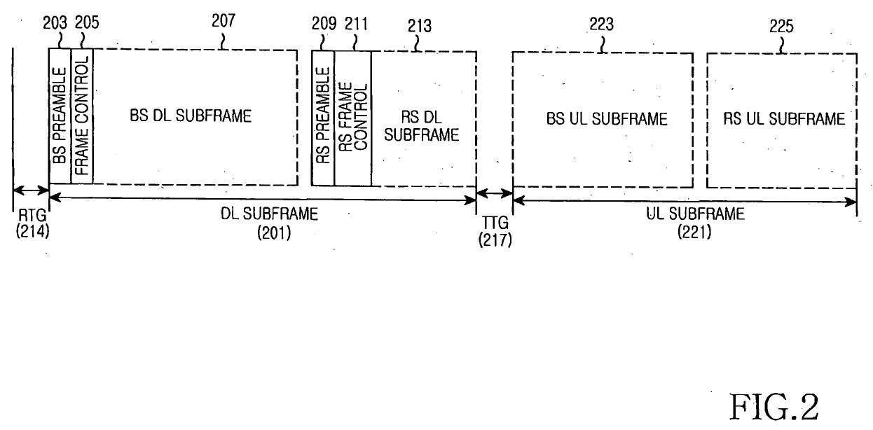

FIG. 2 shows a frame format for a Time Division Multiplexing (TDM) multi-hop relay cellular network according to the present invention. In the accompanying drawings, the horizontal axis represents time, and the vertical axis represents frequency.

Referring to FIG. 2, the frame is divided into a downlink (DL) subframe 201 and an uplink (UL) subframe 22 1.

The DL subframe 201 sequentially includes a Base Station (BS) DL subframe section and a Relay Station (RS) DL subframe section.

The BS DL subframe section sequentially includes a BS preamble 203 (BS training signal), a frame control 205, and a BS DL subframe 207 for data transmission to one or multiple RSs and MS_{BS}S.

The RS DL subframe section sequentially includes an RS preamble 209 (RS training signal), an RS frame control 211, and an RS DL subframe 213 for data transmission to one or multiple MS_{RS}S.

The UL subframe 221 is divided into a BS UL subframe 223 and an RS UL subframe 225.

The BS UL subframe 223 includes an UL burst for data transmission from the RS or MS_{BS} to a BS. The RS transmits some RS UL bursts received from one or multiple MS_{RS}S in the previous frame to the BS.

The RS UL subframe 225 includes one or multiple UL bursts for data transmission from the MS_{RS} to the RS.

Meanwhile, a Transmit/Receive Transition Gap (TTG) 217 (time guard region) exists between the DL subframe 201 and the UL subframe 221. Further, a Receive/Transmit Transition Gap (RTG) 214 (time guard region) exists between a UL subframe 221 of the previous frame and the DL subframe 201. The time guide regions are provided in consideration of delay spread and DL/UP switching delay.

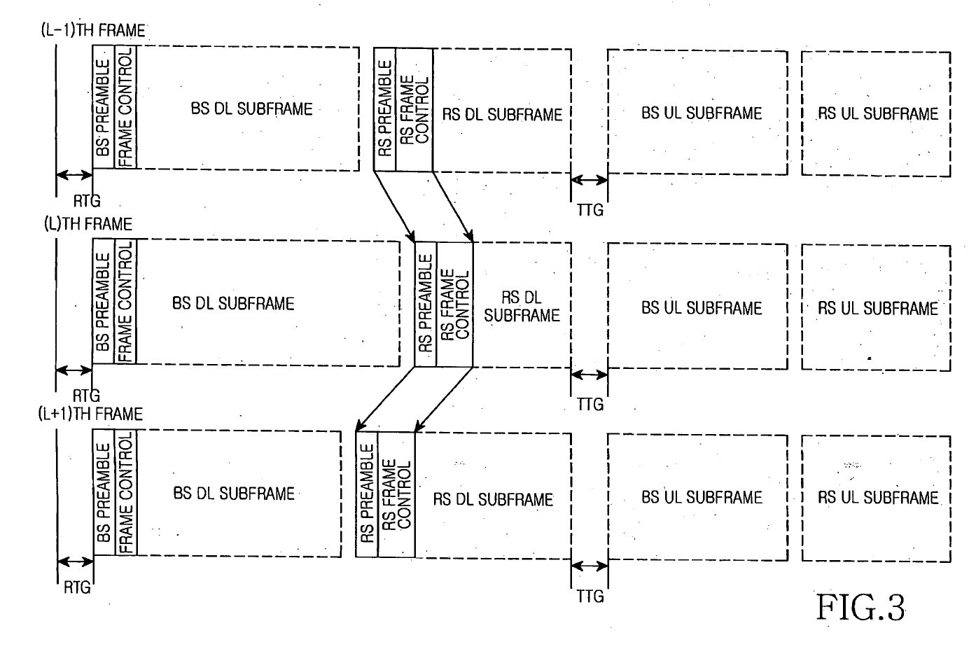

In the above-described frame format using an RS, the sizes of the subframes can be dynamically changed (allocated) depending on the load of the BS or RS as shown in FIG. 3.

FIG. 3 illustrates dynamic changes of subframe lengths in a multi-hop relay cellular network depending on the load of a cell according to the present invention. Referring to FIG. 3, the lengths of BS and RS DL subframes are dynamically changed over consecutive frames depending on the loads of a BS and an RS. Therefore, the starting point of the RS DL subframe changes.

That is, the location of an RS preamble changes over the consecutive frames according to the loads of the BS and RS, making initial synchronization difficult.

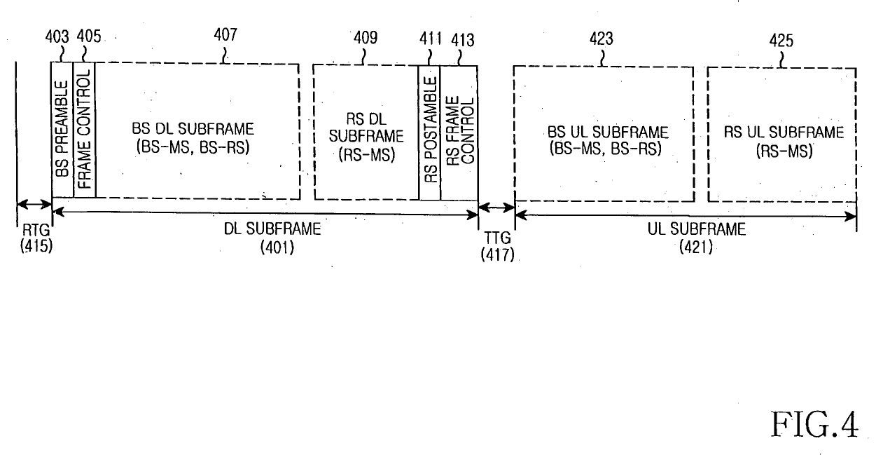

FIG. 4 shows a frame format for a TDM multi-hop relay cellular network according to the present invention. The frame format provides a way of solving the difficulty of initial synchronization occurring in FIG. 2 and FIG. 3.

Referring to FIG. 4, the frame is divided into a DL subframe 401 and a UL subframe 421.

The DL subframe 401 sequentially includes a BS DL subframe section and an RS DL subframe section.

The BS DL subframe section sequentially includes a BS preamble 403 (BS training signal), a frame control 405, and a BS DL subframe 407 for data transmission to an RS or an MS_{BS}.

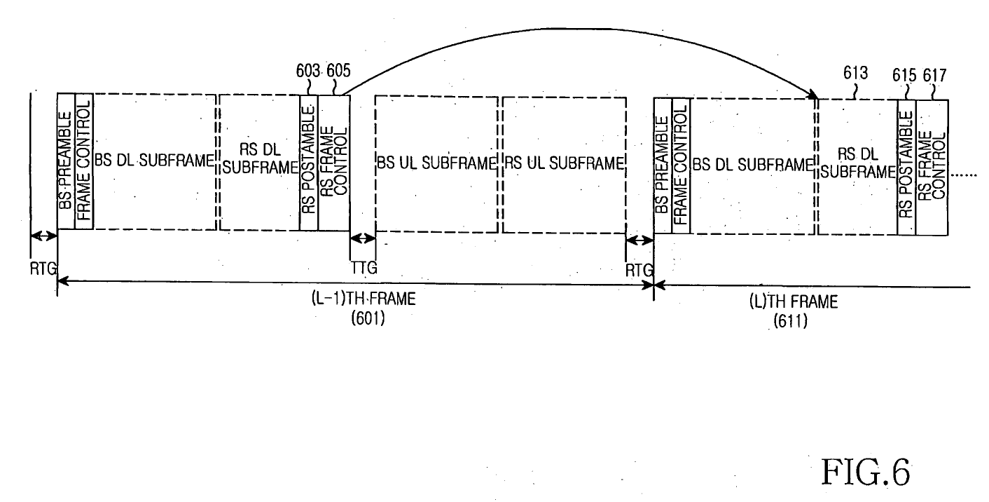

The RS DL subframe section sequentially includes an RS DL subframe 409 for data transmission from the RS to an MS_{RS}, an RS postamble 411 (RS training signal), and an RS frame control 413. The RS frame control 413 transmits control information including the start point of the RS DL subframe 409 in the next frame as shown in FIG. 6. For example, referring to FIG. 6, an RS control frame 605 of an (I−1)^{th} frame 601 transmits control information including the start point of an RS DL subframe 613 in the next (I)th frame 611.

The UL subframe 421 is divided into a BS UL subframe 423 and an RS UL subframe 425.

The BS UL subframe 423 includes one or multiple UL bursts for data transmission from the RS or MS_{BS} to a BS. The RS transmits an RS UL subframe that consists of UL bursts received from one or multiple MS_{RS}S in the previous frame to the BS.

The RS UL subframe 425 includes one or multiple UL bursts for data transmission from the MS_{RS} to the RS.

Meanwhile, a TTG 417 (time guard region) exists between the DL subframe 401 and the UL subframe 421. Further, an RTG 415 (time guard.region) exists between an UL subframe 421 of the previous frame and the DL subframe 401. The time guide regions are provided in consideration of delay spread and DL/UP switching delay.

The BS determines the start point of the RS DL subframe 409 depending on the loads of the RS and BS. Therefore, a BS training signal and a B.S control channel are transmitted at the start of the DL subframe 401 (at the BS preamble 403 and the frame control 405), and an RS training signal and an RS control channel are transmitted at the end of the DL subframe 401 (at the RS postamble 411 and the RS frame control), thereby efficiently performing synchronization.

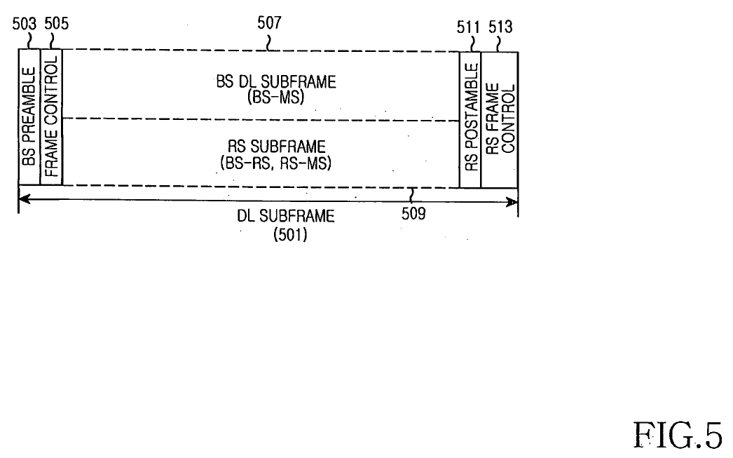

FIG. 5 shows a frame format for a Frequency Division Multiplexing (FDM) multi-hop relay cellular network according to the present invention. In the following description, an FDM DL subframe is used to explain the present invention;

Referring to FIG. 5, a DL subframe 501 includes a BS preamble 503 (BS training signal) and a frame control 505 at a leading edge portion. The DL subframe 501 further includes an RS postamble 511 (RS training signal) and an RS frame control 513 at a trailing edge portion.

The DL subframe 501 further includes a BS DL subframe 507 and an RS subframe 509 that are transmitted at the same time interval using different frequency bands. The BS DL subframe 507 includes one or multiple bursts for data transmission from a BS to the MS_{BS}. The RS subframe 509 includes BS DL subframe for data transmission from the BS to the RS, and an RS DL subframe for data transmission from the RS to the MS_{RS}. Each subframe consists of multiple bursts.

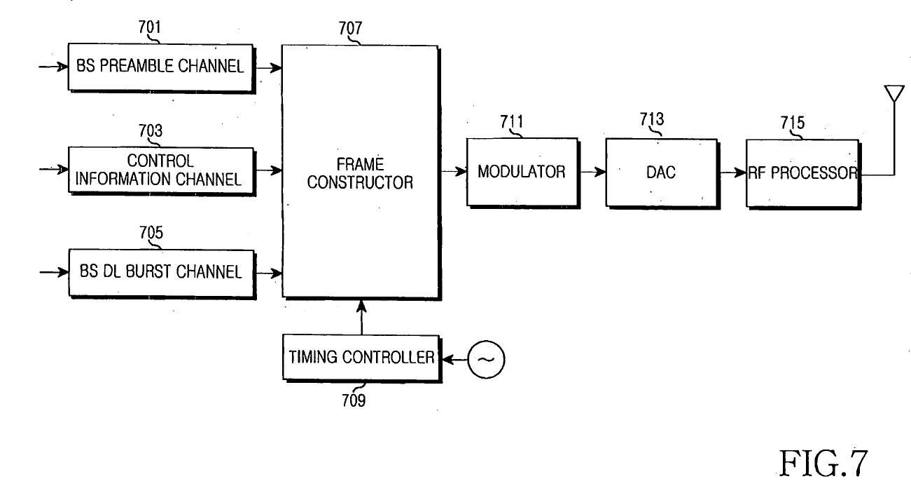

FIG. 7 shows a BS transmitter according to the present invention. The BS transmitter includes a BS preamble channel 701, a control information channel 703, a BS DL burst channel 705, a frame constructor 707, a timing controller 709, a modulator 711, a Digital/Analog Converter (DAC) 713, and a Radio Frequency (RF) processor 715.

The BS preamble channel 701 transmits a preamble (BS training signal), and the control information channel 703 transmits control information. including the decoding information of a BS DL subframe. The BS DL burst channel 705 transmits multiple DL bursts for an MS_{BS} or an RS.

The frame constructor 707 receives the preamble, the control information, and the DL burst from the BS preamble channel 701, the control information channel 703, and the BS DL burst channel 705, and then constructs a BS DL subframe. At this point, the frame constructor 707 receives a timing signal from the timing controller 709 to construct the BS DL subframe sequentially including the preamble, the control information, and the DL burst. The timing signal is used to determine a time point when the BS DL subframe is transmitted in one frame.

The modulator 711 modulates the BS DL subframe using a predetermined modulation scheme and outputs the resulting digital signal to the DAC 713. The DAC 713 converts the digital signal into an analog signal.

The RF processor 715 receives the digital signal from the DAC 713 and increases the frequency of the digital signal so as to convert it into an RF signal. Then, the RF processor 715 transmits the RF signal through an antenna.

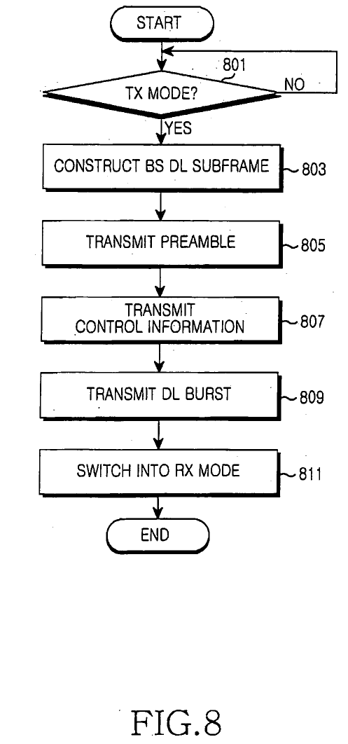

FIG. 8 shows transmission procedures of a BS according to the present invention. In step 801, a BS determines whether it is in transmitting (TX) mode. If so, the BS constructs a BS DL subframe in step 803, where the BS DL subframe uses a preamble (BS training signal), control information and multiple DL bursts in order to transmit data to an MS_{BS} or an RS.

In steps 805, 807 and 809, the BS transmits the BS DL subframe to the MS_{BS} or the RS. That is, the BS sequentially transmits the preamble, the control information and the DL burst to the MS_{BS} or the RS.

After that, the BS switches into a receiving (RX) mode in step 811. The BS determines the start point of an RS DL subframe depending on the loads of the BS and the RS.

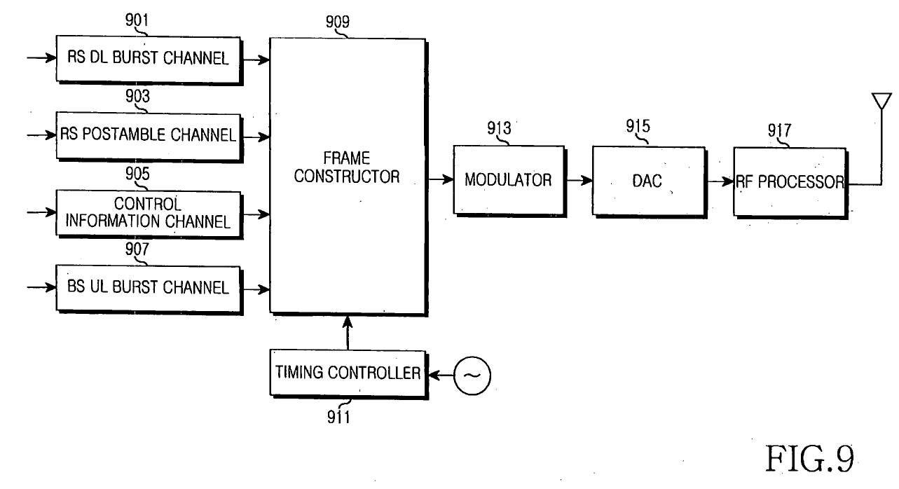

FIG. 9 shows an RS transmitter according to the present invention. The RS transmitter includes an RS DL burst channel 901, an RS postamble channel 903, a control information channel 905, an BS UL burst channel 907, a frame constructor 909, a timing controller 911, a modulator 913, a DAC 915, and an RF processor 917.

The RS DL burst channel 901 transmits a DL burst for an MS_{RS}, and the RS postamble channel 903 transmits an RS postamble (RS training signal). The control information channel 905 transmits control information including the start point of an RS DL subframe, and the BS UL burst channel 907 transmits an UL burst for a BS.

The frame constructor 909 receives the RS DL burst, the RS postamble, the control information from the RS DL burst channel 901, the RS postamble channel 903 and the control information channel 905 to construct the RS DL subframe. Further, the frame constructor 909 receives a BS UL burst from the BS UL burst channel 907 to construct a BS UL subframe.

The frame constructor 909 receives a timing signal from the timing controller 911 to construct the BS DL subframe sequentially including the DL burst, the RS postamble, and the control information. The timing signal is used to determine a time point when the BS DL subframe is transmitted in one frame.

The modulator 913 modulates the RS DL subframe using a predetermined modulation scheme and outputs the resulting digital signal to the DAC 915. The DAC 915 converts the digital signal into an analog signal.

The RF processor 917 receives the digital signal from the DAC 915 and increases the frequency of the digital signal so as to convert it into an RF signal. Then, the RF processor 917 transmits the RF signal through an antenna.

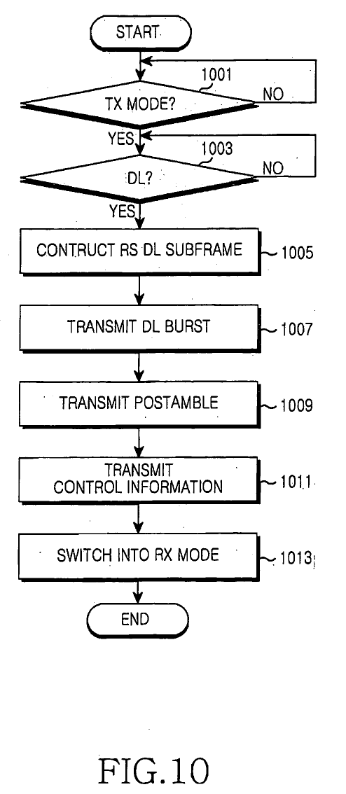

FIG. 10 shows transmission procedures of an RS according to the present invention. In the following description, for example, the RS transmits an RS DL subframe to an MS_{RS}. In step 1001, the RS determines whether it is in a TX mode. If so, the RS determines whether a DL is established for transmitting data to the MSRS in step 1003.

If so, the RS constructs the RS DL subframe in step 1005, where the RS DL subframe sequentially includes a DL burst, a postamble (RS training signal), and control information to transmit the DL burst to the MS_{RS}.

In steps 1007, 1009, and 1011, the DL burst, the postamble, and the control information of the RS DL subframe are sequentially transmitted.

After that, the RS switches into an RX mode in step 1013.

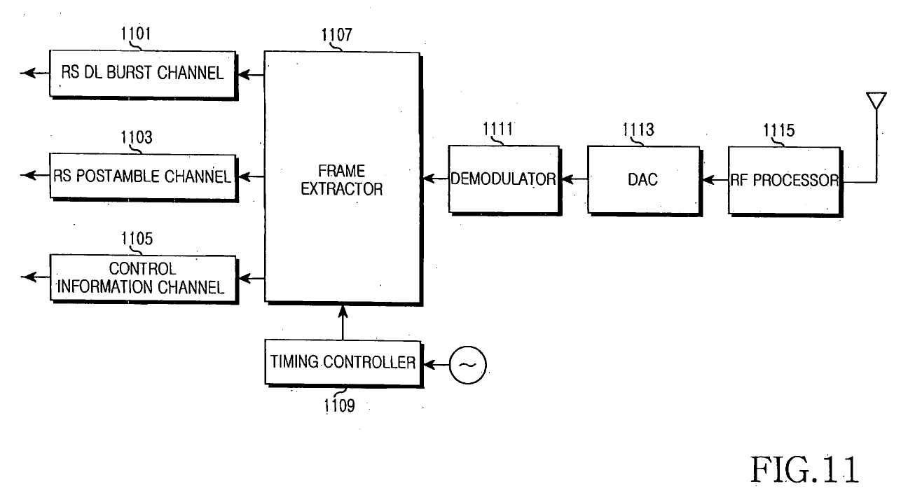

FIG. 11. shows an MS_{RS} receiver receiving a signal from an RS according to the present invention. The MS_{RS} receiver includes an RS DL burst channel 1101, an RS postamble channel 1103, a control information channel 1105, a frame extractor 1107, a timing controller 1109, an demodulator 1111, an Analog/Digital Converter (ADC) 1113, and an RF processor 1115.

The RF processor 1115 receives an RF signal through an antenna and decreases the frequency of the RF signal so as to convert it into a baseband signal. The ADC 1113 receives the baseband signal from the RF processor 1115 and converts it into a digital signal.

The demodulator 1111 receives the digital signal from the ADC 1113 and demodulates it using a predetermined demodulation scheme.

The frame extractor 1107 splits an output frame of the demodulator 1111 into an RS DL burst, an RS postamble, and control information. The frame extractor 1107 receives a synchronization signal and time information from the timing controller 1109 so as to synchronize with the RS using the synchronization signal and output receiving frames after separating the frames based on the time information. A synch detector (not shown) of the timing controller 1109 detects the synchronization signal from RS preambles of the previous frames received from the demodulator 1111.

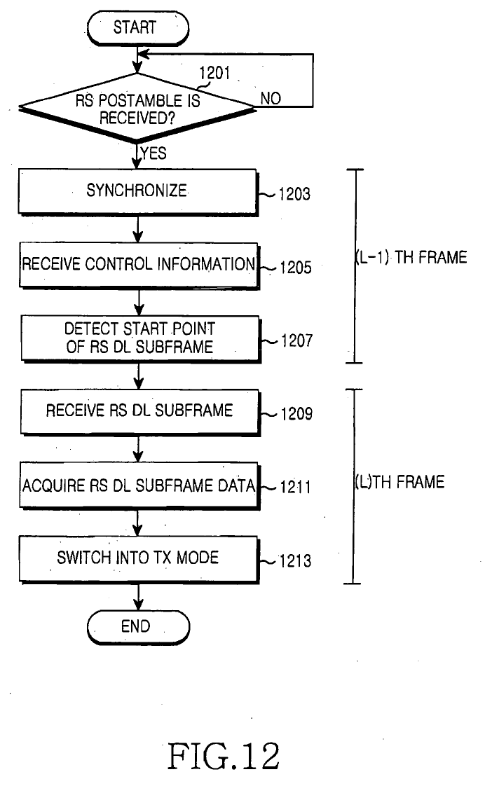

FIG. 12 shows operation procedures of an MS receiving a signal from an RS according to the present invention. If the MS cannot receive a training (preamble) signal (refer to the BS preamble 403 in FIG. 4) from a BS, the MS establishes a link to the RS and determines whether a training (postamble) signal (refer to the RS postamble 411 in FIG. 4) is received from the RS in step 1201.

If so, the MS synchronizes with the RS using the postamble signal in step 1203. The synchronization between the MS and the RS is performed using postamble (training) signals included in several frames received from the RS.

In step 1205, the MS obtains an RS control channel (frame control) from an (I−1)^{th} frame received from the RS. The RS control channel includes frame control information and the start point of an RS DL subframe of the next frame (i.e., I^{th} frame).

After that, in step 1207, the MS reads the start point of the RS DL subframe of the I^{th} frame from the RS control channel. In step 1209, the MS determines whether the RS DL subframe of the I^{th} frame is received at the read start point (time). The RS DL subframe includes information about an RS UL subframe of the same frame and information about an RS DL control of the next frame.

When the RS DL subframe of the I^{th} frame is received, the MS demodulates the RS DL subframe to acquire data transmitted from the RS in step 1211. In step 1213, the MS switches into TX mode. The process shown in FIG. 12 ends at this point.

As described above, the lengths of the subframe sections are adjusted depending on the loads (traffics) on direct and relay links in a multi-hop relay cellular network, and at the same time, the training signal and the frame control channel are respectively located at the preamble and the postamble of the DL subframe section of each frame. Therefore, difficulties of initial synchronization, handoff, and cell search can be removed from mobile stations (MS). Furthermore, multi-link bursts can be located between the preamble and the postamble by TDM or FDM, thereby providing flexible data transmission. Moreover, the TDM frame structure reduces interference between different links.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A relay station (RS) transmitter in a relay network, the RS transmitter comprising:
a frame constructor for generating a downlink (DL) subframe to be transmitted to a mobile station (MS), the DL subframe including a DL burst, a training signal in a postamble, and a control channel; and
a timing controller for generating a timing signal providing information about a time period for transmitting the DL subframe.

2. The RS transmitter of claim 1, wherein the DL burst, the training signal, and the control channel of the DL subframe are sequentially transmitted under a control of the timing controller.

3. The RS transmitter of claim 1, wherein the control channel has control information including a start point of a DL subframe of a next frame to be transmitted to the MS.

4. A mobile station (MS) receiver in a relay network, the MS receiver comprising:
a frame extractor for splitting a downlink (DL) subframe of an I^{th} frame received from a relay station (RS) into a DL burst, a training signal, and a control channel; and
a synchronization detector for acquiring a synchronization signal from training signals of the i^{th} frame; and
a timing controller for providing a timing signal used for receiving a DL subframe of an (i+1)^{th} frame according to the synchronization signal of the (i)th frame.

5. The MS receiver of claim 4, wherein the training signal is located in a postamble of the DL subframe.

6. The MS receiver of claim 4, wherein the control channel has control information including a start point of a DL subframe of a next frame.

7. A method for operating a relay station (RS) to transmit data in a relay network, the method comprising the steps of:
constructing a downlink (DL) subframe sequentially including DL data, a training signal, and a control channel;
transmitting the DL subframe to a mobile station (MS); and
switching the RS into a receiving (RX) mode.

8. The method of claim 7, wherein the training signal is located in a postamble of the DL subframe.

9. The method of claim 7, wherein the control channel has control information including a start point of a DL subframe of a next frame.

10. The method of claim 7, wherein the step of transmitting the DL subframe includes sequentially transmitting the DL data, the training signal, and the control channel.

11. A method for operating a mobile station (MS) to receive data in a relay network, the method comprising the steps of:
when receiving a downlink (DL) subframe of an i^{th} frame from a relay station (RS), acquiring a synchronization signal using a training signal included in the DL subframe;
determining a start point of a DL subframe of an (i+1)^{th} frame to be received from the RS by using a control channel included in the DL subframe of the i^{th} frame; and
when the (i+1)^{th} frame is received from the RS, receiving the DL subframe of the (i+1)^{th} frame based on the start point determined using the control channel.

12. The method of claim 11, wherein the DL subframe sequentially comprises a DL burst, the training signal, and the control channel.

13. The method of claim 11, wherein the training signal is located in a postamble of the DL subframe.

14. The method of claim 11, wherein the step of acquiring the synchronization signal includes acquiring a synchronization signal using training signals included in a plurality of frames received from the RS.

15. The method of claim 11, further comprising demodulating the DL subframe receiving from the RS.

16. A method for constructing a subframe in a relay network, the method comprising the steps of:
constructing a first subframe in a first section of the subframe for transmitting the first subframe from a base station (BS) to a relay station (RS) or a first mobile station (MS) connected to the BS by a direct link, the first subframe sequentially including a synchronization channel, control information, and a downlink (DL) burst; and
constructing a second subframe in a second section of the subframe for transmitting the second subframe from the RS to a second MS connected to the RS by a relay link, the second subframe sequentially including a DL burst, a synchronization channel, and control information.

17. The method of claim 16, wherein the synchronization channel of the first subframe is located at a leading end of the first section of the subframe.

18. The method of claim 16, wherein the synchronization channel of the second subframe is an RS training signal located at a trailing end of ihe second section of the subframe.

19. The method of claim 16, wherein the control information of the second subframe has information about a start point of an RS DL subframe included in a next frame.
